(19) United States
(12) Patent Application Publication
(10) Pub. No.: US 2017/0225382 A1
(43) Pub. Date: Aug. 10, 2017

(54) EXTRUSION-BLOW-MOULDING METHOD AND DEDICATED ROBOT

(71) Applicant: MACHINES PAGES, Foncine Le Haut (FR)

(72) Inventor: Philippe OLICHON, Foncine Le Haut (FR)

(73) Assignee: MACHINES PAGES, Foncine Le Haut (FR)

(21) Appl. No.: 15/514,979

(22) PCT Filed: Sep. 11, 2015
(86) PCT No.: PCT/EP2015/070900

§ 371 Date: Mar. 28, 2017

(30) Foreign Application Priority Data
Sep. 29, 2014 (FR) 1459193

(51) Int. Cl. B29C 49/32; B29C 49/24; B29C 49/42; B29C 49/04

(52) U.S. Cl. CPC B29C 49/32; B29C 49/04; B29C 49/24; B29C 49/421; B29C 2049/2412; B29C 2049/2443; B29K 2101/12

(57) ABSTRACT

Some embodiments are directed to an extrusion blow-molding method for the manufactures of blown objects with at least one label integrated in situ, and also including a robot implementing this method.

### CROSS REFERENCE TO RELATED APPLICATION

This application is a National Phase filing under 35 C.F.R. §371 of and claims priority to PCT Patent Application No.: PCT/EP2015/070900, filed on Sep. 11, 2015, which claims the priority benefit under 35 U.S.C. §119 of French Application No.: 1459193, filed on Sep. 29, 2014, the contents of which are hereby incorporated in their entireties by reference.

### BACKGROUND

Some embodiments relate to an extrusion blow-molding method for the manufactures of blown objects with at least one label integrated in situ. It also relates to a robot implementing this method.

### RELATED ART

The extrusion blow-molding method can be used for the manufacture of hollow objects such as containers, flasks, canisters or bottles made of thermoplastic. The method is based on the extrusion by an extrusion head of a parison 3 having a tubular shape which is then cut, placed in a mold and blow-molded to take the shape of the cavity of the mold.

Referring to FIG. 1, a related art extrusion blow-molding machine includes an extruder which prepares material initially in the form of a granules of a thermoplastic material paste under pressure and an extrusion head 1 which provides for the transfer of the melted material from the extruder toward a die which regulates the shape and the thickness of the parison 3.

A robot is positioned next to the extruder to maneuver a mold 311 and discharge the blown objects. Cooling channels in which circulates a heat transfer fluid serve to remove heat from the thermoplastic material to solidify the part in the mold 311. The robot includes a clamp 31 including the mold 311 to close the mold around the parison 3 extruded by the extrusion head 1 in a generally vertical extrusion direction. The mold 311 includes two shells 3111 with cavities 3112, the shells being movable in a clamping direction perpendicular to the extrusion direction. The clamp 31 further includes gripping means 312 for again picking up a first blown object 36a retained by a blow pipe 33. Transfer means allow transferring the clamp 31 in a transfer direction perpendicular with respect to the extrusion direction and to the clamping direction. The blow pipe 33 is slidably mounted in the extrusion direction, offset from the pitch achieved by the transfer means, to insert itself in one end of the parison 3 for blowing it into the mold 311 and forming a second blown object 36b. A discharge system 35 is positioned in the transfer direction to receive the first blown object 36a. The blow pipe 33 is also capable of retaining the second object 36b during the opening of the mold 311.

In certain versions, insertion means 34 are positioned opposite to the clamp 31 with respect to the extrusion axis for inserting at least one sheet to the surface of at least one of the cavities. During the blowing step, the sheet is pressed against the wall of the mold and the wall of the blown object and is then integrated by at least partial fusion to the wall of the blown object. This makes it possible to cover the outer surface of the blown object with a label, for example. The sheet is preferably made of thermoplastic so as to facilitate the recycling of the blown object. Moreover, the label is strongly bonded to the wall of the blown object, which confers high resistance upon it.

Blown objects are manufactured on such an installation by a succession of cycles of which a single one is described hereafter, the others being identical. The first step of the cycle is selected arbitrarily. The description that follows refers to a first and a second blown object 36a, 36b which are objects that follow each other in the manufacturing cycle.

In an initial position, shown in FIG. 2a, the parison 3 is undergoing extrusion. The mold 311 is closed and the clamp 31 is disengaged from the extrusion head 1. The blow pipe 33 is engaged in the mold 31 which contains the second blown object 36b. The gripping means 312 hold by a neck the first blown object 36a above the discharge system.

In the first step, shown in FIG. 2b, the clamp 31 opens so that the second object 36b is released from the mold 311. The gripping means 312 release the first object which is then transferred to the discharge system 35, a conveyor belt for example.

In the second step, shown in FIG. 2c, the transfer means move the clamp 31 to place the mold 311 around the parison 3.

In the third step, shown in FIG. 2d, the insertion means 34, in the form of sliding arms, introduce two sheets to place them respectively in the cavities of the two shells of the mold 311, and deposit them.

In the fourth step, shown in FIG. 2e, the insertion means 34 withdraw.

In the fifth step, shown in FIG. 2f, the clamp 31 closes itself so as to insert the parison 3 in the mold. The portion of the parison 3 in the mold is cut to detach it from the parison 3 currently being extruded. In the same movement, the gripping means 312 seize the second blown object 36b by the neck, in proximity to the connection with the blow pipe 33.

In the sixth step, shown in FIG. 2g, the blow pipe 33 moves upward to disengage from the second blown object 36b, held by the gripping means 312.

In the seventh step, shown in FIG. 2h, the transfer means move the clamp 31 with the second object 36b so that the blow pipe 33 is facing the mold 311. At this moment, the second blown object 36b is above the discharge system 35.

In the eighth step, the blow pipe 33 drops and blows air into the parison 3 to press the walls of the parison 3 into the cavities of the shells. A third object is thus formed, bearing on its surface the sheets which were inserted into the mold 311.

The position achieved is that of the initial position, although the second object 36b has replaced the first in the gripping means 312. The cycle then resumes at the first step.

In certain installations, it is desired to use two blow-molding stations so as to have greater productivity, as shown in FIG. 3. The installation then comprises a robot formed from two robots as previously described placed on either side of the extruder, excluding the insertion means. In fact, the second clamp 41b takes the place of the insertion means of the first assembly, and conversely. In this configuration, it is not possible to have insertion of the sheets into the molds. The parisons 3 produced are taken alternately by one or the other of the clamps 41a, 41b.

An installation is proposed that still allows insertion of sheets, as shown in FIG. 4. In this configuration, the discharge means are replaced by a receptacle 55 to receive the blown objects that fall by gravity after the opening of the clamp 51. The space freed by the discharge system is used by the insertion means 54 to insert the sheets, not when the clamp 51 is surrounding the parison 3 but when it is still surrounding the blown object 56 held by the blow pipe 53.

Current configurations pose certain problems. The insertion of the sheets occurs when the parison 3 is between the shells of the mold in the case of the single machine, or when the blown object is between the shells in the case of the double machine. This limits the space available for passage of the arms which carry the sheets, or requires providing a large opening path for the molds. In the first case, the arms can lack stiffness and hence accuracy in placement. In the second case, it is necessary to provide for sliding members for opening the clamps that are larger, hence more expensive, heavier and requiring longer operating times. This problem is even more pronounced in the case of double installations, because the blown object is of larger dimensions than the parison 3.

Another problem with double machines with sheet insertion is that the fact of releasing the blown objects requires providing specific operations to stow them, while the discharge system, for example a conveyor belt, makes it possible to handle them more easily. With these installations, it is also necessary to provide that the arms for depositing the sheets withdraw beyond the position of the blown object held by the gripping means so as not to hinder discharge. This requires making very long arms which often lack stiffness and accuracy for depositing inserts. For this reason as well, the installation is very bulky.

### SUMMARY

Some embodiments cover a method and an extrusion blow-molding robot with limited bulk, maintaining good stiffness of the insertion means and allowing the use of a discharge system.

With these objectives in mind, some embodiments cover an extrusion blow-molding method according to which:
at least one parison is extruded in an extrusion direction
a first clamp including a first mold is closed around the parison in a first clamping direction perpendicular to the extrusion direction, at least one cavity of the first mold containing at least one sheet, and the first clamp picks up again at least one first blown object retained by at least one first blow pipe,
the first clamp is transferred in a first transfer direction inclined with respect to the extrusion direction and perpendicular to the first clamping direction along a first level,
the first blow pipe is inserted on one end of the parison to blow it into the first mold and form at least one second blown object, the sheet being integrated into the second blown object, and
the first mold is opened in the first clamping direction and retaining the second object on the first blow pipe and the first blown object is released on a first discharge system,
   During the step of extruding the parison, when the first mold is opened, the first blown object is transferred by the first blow pipe from the first level to the second level, offset with respect to the first in the extrusion direction, the sheet is placed in the cavity of the first mold by first insertion means, then the first clamp is transferred in the first transfer direction to place the first mold around the parison, and in that the first clamp picks up again the first blown object at the second level during the step of closing the first clamp to transfer it to the first discharge system.

The placement of the sheet in the mold is accomplished, not when the mold is around the parison but prior to the transfer of the mold to this place when the second blown object is extracted toward the second level. The space between the shells of the mold is then completely free. It is thus possible to use insertion means less constrained by the free space, which makes it possible to improve accuracy of placement of the sheet(s) in the mold without increasing the opening travel of the mold. Moreover, the discharge system placed at the second level is above the insertion means, which limits the footprint of the installation. The extrusion head can produce one or more parisons, in which case the mold includes as many cavities as parisons to form as many objects. The blow pipe is also duplicated or subdivided so as to blow into each parison and to pick up as many objects.

According to a second embodiment of the method:
in a second open mold, maneuvered by a second clamp, at least one third blown object is transferred by at least one second blow pipe from the first level to the second level,
at least one second sheet is placed in at least one cavity of the second mold by second insertion means,
a second clamp is transferred in the second transfer direction to place the second mold around the parison when the first clamp is withdrawn, and
the second mold is closed around the parison along a second clamping direction perpendicular to the extrusion direction, and the second clamp picks up again the third blown object retained by the second blow pipe at the second level,
the second clamp is transferred in a second transfer direction inclined with respect to the extrusion direction and perpendicular to the second clamping direction,
the second blow pipe is inserted on one end of the parison to blow it in the second mold and form at least one fourth blown object, the sheet being integrated into the fourth blown object, and
the second mold is opened in the second clamping direction while retaining the fourth blown object on the second blow pipe and the third blown object is released on a second discharge system.

This system uses two blow-molding stations. It makes it possible to produce the installation with little bulk because the two discharge systems are stacked over the insertion means. Moreover, as before, the insertion of the sheets is accomplished without the presence of either the parison or of the blown object. In addition, the insertion means can be in immediate proximity to the mold, which reduces the length of the sliding arms for the insertion means. These two combined features increase considerably the stiffness of the insertion means and thus the accuracy in positioning the sheets, while making such an installation much more reliable. It is also noted that it is thus possible to use insertion means jointly with a discharge system such as a conveyor belt, while according to the prior art only the discharge of the blown objects by gravity was known when using insertion means.

According to other features:
the first or the second transfer direction is perpendicular to the extrusion direction,
the first and the second transfer directions are parallel, and
the parison is cut transversely during the closure of the mold. The cut can be accomplished by tooling integrated into the mold or into the extruder.

Some embodiments also cover a robot for an extrusion blow-molding machine including:
a first clamp including a first mold for closing the first mold around at least one parison extruded by an extrusion head in an extrusion direction, the first mold including shells with cavities, the shells being movable in a first clamping direction perpendicular to the extrusion direction, the first clamp further including first gripping means for picking up again at least one first blown object retained by at least one first blow pipe,
first insertion means for inserting at least one sheet to the surface of at least one of the cavities,
first transfer means for transferring the first clamp in a first transfer direction inclined with respect to the extrusion direction and perpendicular to the first clamping direction along a first level,
the first blow pipe being capable of being inserted on one end of the parison to blow it in the first mold and form at least one second blown object, the sheet being integrated into the second blown object and capable of retaining the second object on the first blow pipe during the opening of the first mold by the first clamp, and
a first discharge system positioned to receive the first blown object by the first gripping means during the opening of the first clamp,
   The first blow pipe is arranged for transferring the first blown object from the first level to a second level offset with respect to the first in the extrusion direction so as to remove the first blown object from the first mold, in that the first insertion means are arranged for inserting the sheet facing the first blow pipe, in that the first gripping means are arranged for picking up again the first blown object at the second level during closure of the first clamp to transfer it to the first discharge system, and in that the robot is controlled so as to implement the method as described previously.

According to a second embodiment, the robot further includes:
a second clamp including a second mold for closing the second mold around the parison in a second clamping direction perpendicular to the extrusion direction, the second mold including shells with cavities, and second gripping means for picking up again at least one third blown object retained by at least one second blow pipe,
second insertion means for inserting at least one sheet to the surface of at least one of the cavities of the second mold,
second transfer means for transferring the second clamp in a second transfer direction inclined or perpendicular with respect to the extrusion direction, and perpendicular to the second clamping direction along the first level,
the second blow pipe being capable of being inserted on one end of the parison to blow it in the second mold and form at least one fourth blown object, the sheet being integrated into the fourth blown object, the second blow pipe being capable of retaining the fourth object on the second blow pipe during the opening of the second mold by the second clamp, and arranged to transfer the fourth blown object from the first level to the second level, and
a second discharge system positioned to receive the third blown object by the second gripping means during the opening of the second clamp.
   The second gripping means is arranged to pick up again the third blown object at the second level during the closure of the second clamp to transfer it to the second discharge system, the robot being controlled so as to implement the method according to the second embodiment.

### BRIEF DESCRIPTION OF THE FIGURES

The invention will be better understood and other features and advantages will appear upon reading the description that follows, the description referring to the appended drawings wherein:

FIG. 1 is a schematic view of an extrusion blow-molding installation according to the prior art at a station with means for inserting sheets;

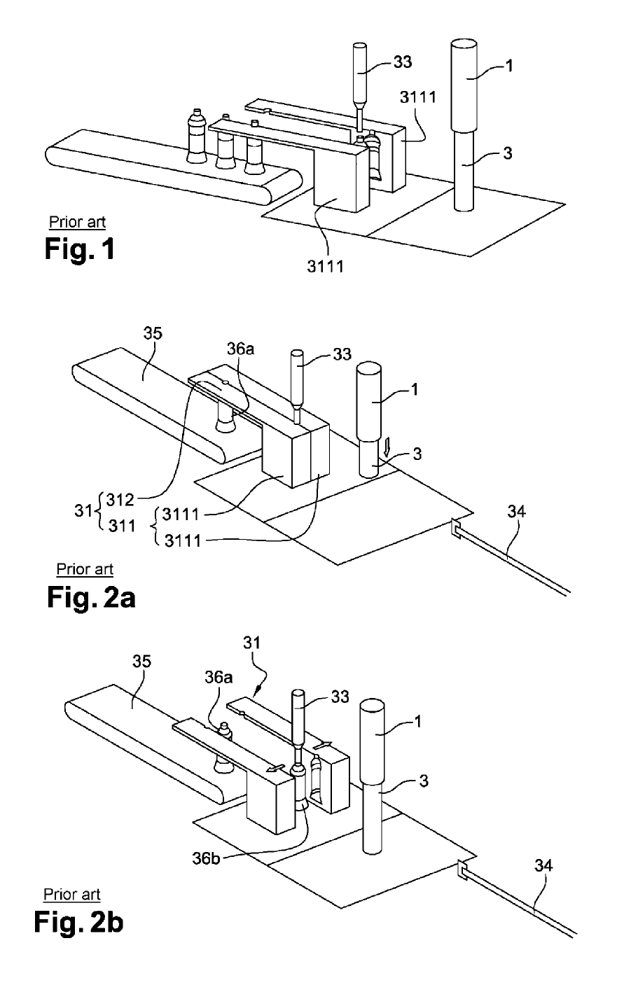

FIGS. 2a to 2h show the steps of a method implemented by the installation of FIG. 1;

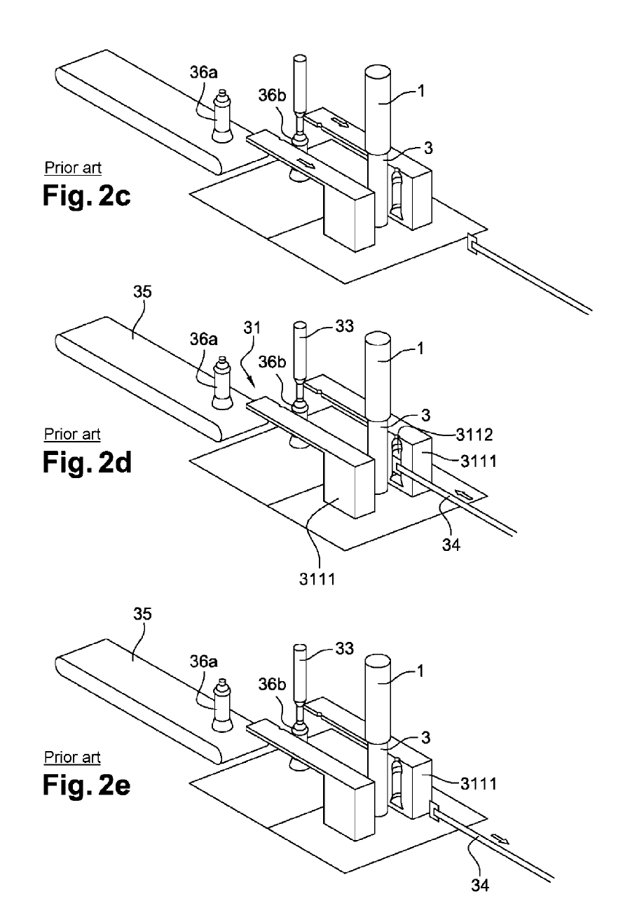

FIG. 3 shows another installation according to the prior art, with two blow-molding stations;

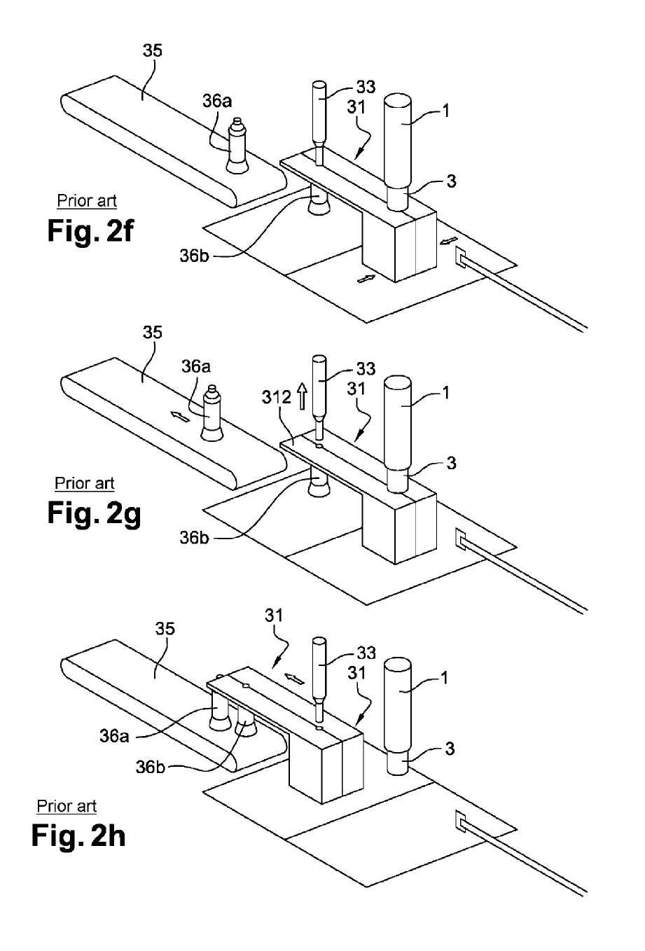

FIG. 4 shows another installation according to the prior art, with two blow-molding stations and means for inserting sheets;

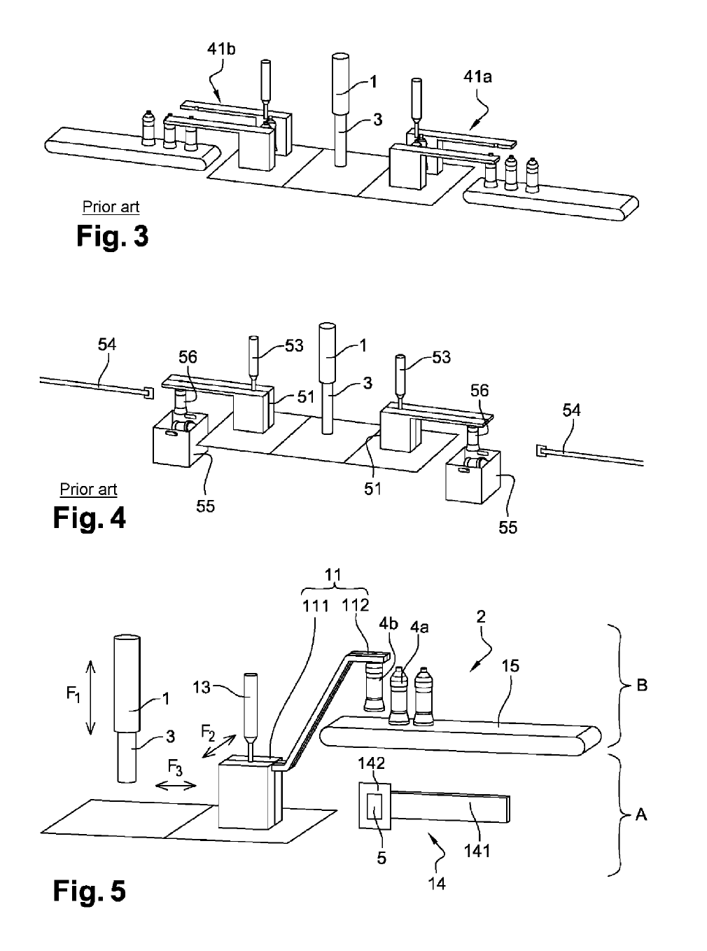

FIG. 5 is a schematic view of an extrusion blow-molding installation at a station with means for inserting sheets according to a first embodiment of the invention;

FIGS. 6a to 6i show the steps of a method implemented by the installation of FIG. 5;

FIG. 7 is a schematic view of an extrusion blow-molding installation with two stations with means for inserting sheets according to a second embodiment of the invention.

### DETAILED DESCRIPTION OF THE EMBODIMENTS

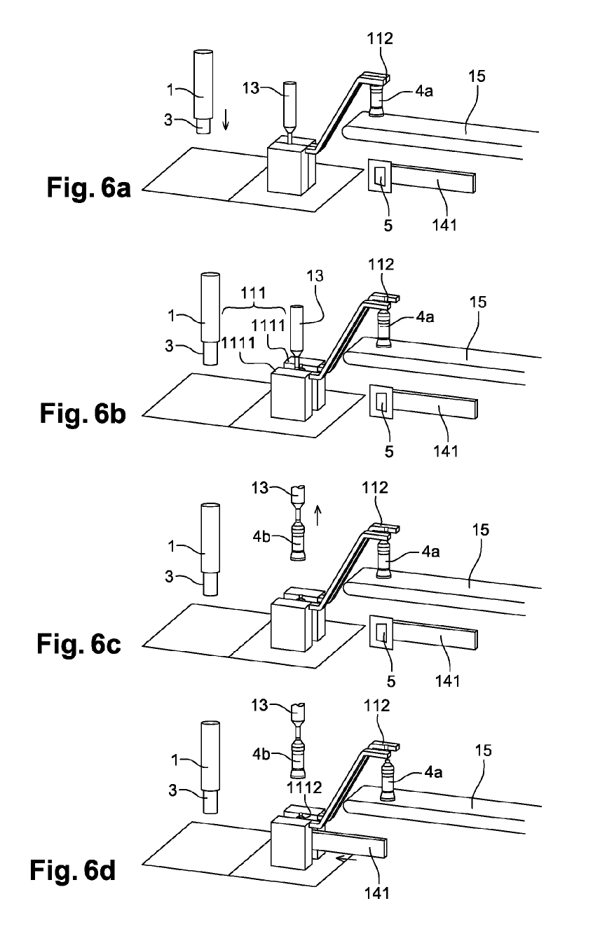

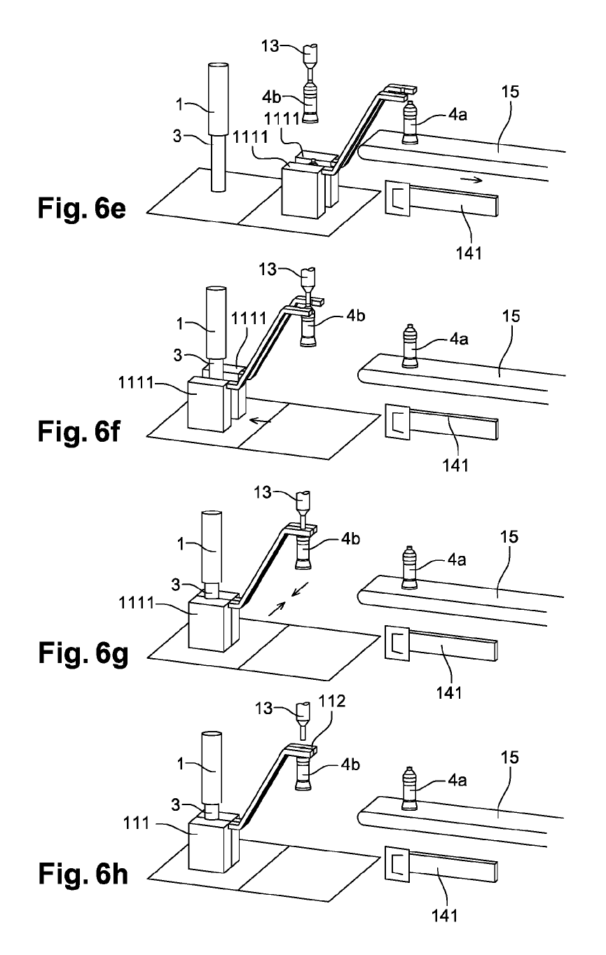

Referring to FIGS. 5 and 6a to 6i, an extrusion blow-molding installation includes an extruder whereof only the head 1 is shown in the figures, and a robot 2 according to a first embodiment of the invention. The extrusion head 1 continuously produces a parison 3 of tubular shape in an extrusion direction F1, in this case vertically downward. The robot 2 includes a first clamp 11 including a first mold 111 to close the first mold 111 around the parison 3. The first mold 111 includes shells 1111 with cavities 1112. The shells 1111 are movable along a first clamping direction F2 perpendicular to the extrusion direction F1, i.e. horizontally.

The robot 2 further includes first transfer means, not shown, to transfer the first clamp 11 in a first transfer direction F3 between the extrusion head 1 and a first blow-molding station along a first level A. The first transfer direction F3 can for example be inclined with respect to the extrusion direction F1 and perpendicular to the first clamping direction F2. In this case, the first transfer direction F3 is perpendicular to the extrusion direction F1, and therefore horizontal.

The first clamp 11 further includes first gripping means 112 to pick up again a first blown object 4a and transfer it, in a manner detailed hereafter.

The robot 2 includes at the blow-molding station a first blow pipe 13 slidably mounted in the extrusion direction F1. The first blow pipe 13 is capable of being inserted, in a blow-molding position, on one end of the parison 3 at the first blow-molding station to blow it in the first mold 111 and form a second blown object 4b. The first blow pipe 13 is further capable of holding the second blown object 4b to bring it to a second level B higher than the first level A so as to remove the second blown object 4b from the first mold 111.

The robot 2 further includes first insertion means 14 for inserting a sheet 5 to the surface of each of the cavities 1112 when the first mold 111 is at the blow-molding station, in the open position. The first insertion means 14 includes two arms 141 slidably mounted, each arm 141 terminated by a gripping device 142 capable of supporting and transporting one of the sheets 5 for presenting it facing the corresponding shell 1111. The arm 141 or the gripping device 142 is further capable of moving in the clamping direction to deposit and transfer the sheet 5 on the shell 1111 in the cavity 1112, in a manner known per se. In the case of depositing the sheet in only one of the shells, only one arm may be used.

The robot 2 also includes a first discharge system 15 positioned for receiving the first blown object 4a by the first gripping means 112 during the opening of the first clamp 11.

The robot 2 is controlled, for example by a programmable logic controller, not shown, to implement the method which will now be described.

In an initial position, shown in FIG. 6a, the parison 3 is being extruded. The first mold 111 is closed and the first clamp 11 is at the blow-molding station. The first blow pipe 13 is engaged in the first mold 111 which contains the second blown object 4b. The first gripping means 112 hold by a neck the first blown object 4a above the first discharge system 15.

In the first step, shown in FIG. 6b, the first clamp 11 opens in such a manner that the second blown object 4b is released from the first mold 111 while being held on the end of the second blow pipe. The first gripping means 112 release the first blown object 4a which is thus transferred to the first discharge system 15.

In the second step, shown in FIG. 6c, the first blow pipe 13 transfers the second object from the first level A to the second level B.

In the third step, shown in FIG. 6d, the first insertion means 14 insert two sheets to place them respectively in the cavities 1112 of the two shells 1111 of the first mold 111, and deposit them.

In the fourth step, shown in FIG. 6e, the first insertion means 14 withdraw.

In the fifth step, shown in FIG. 6f, the transfer means move the first clamp 11 to place the first mold 111 around the parison 3, while the sheets are held in the shells 1111.

In the sixth step, shown in FIG. 6g, the first clamp 11 is closed so as to insert the parison 3 into the first mold 111. In the same movement, the first gripping means 112 seize the second blown object 4b by the neck, in proximity to the connection with the first blow pipe 13.

In the seventh step, shown in FIG. 6h, the first blow pipe 13 moved upward to disengage from the second blown object 4b, held by the first gripping means 112.

In the eighth step, shown in FIG. 6i, the transfer means move the first clamp 11 with the second object so that the first blow pipe 13 is facing the first mold 111. At this time, the second blown object 4b is above the first discharge system 15.

In the ninth step, the first blow pipe 13 drops and blows air into the parison 3 to press the walls of the parison 3 into the cavities 1112 of the shells 1111. A third object is thus formed, bearing on its surface the sheets which were inserted into the first mold 111. The position attained is that of the initial position, except that the second object has replaced the first in the first gripping means 112. The cycle then resumes at the first step.

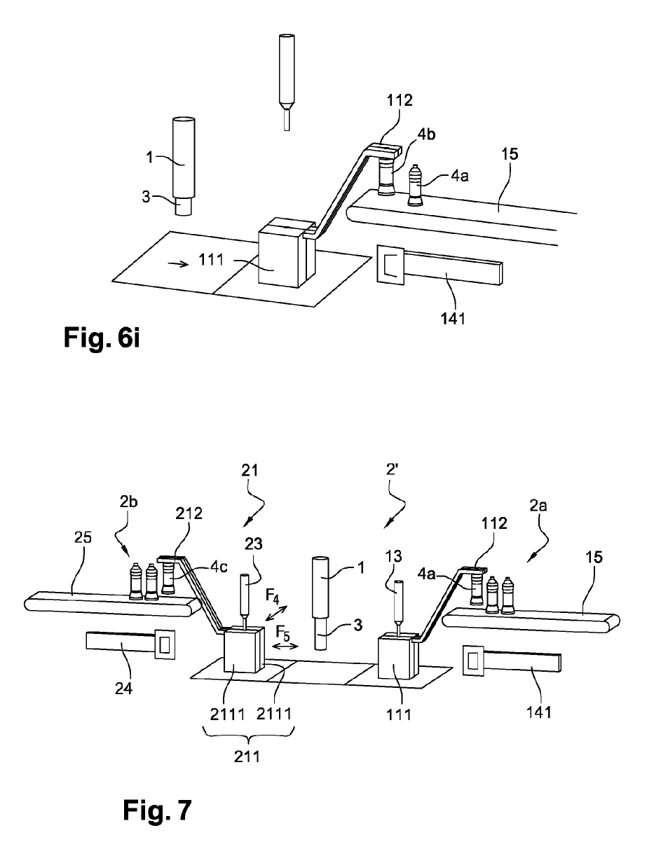

Another installation is shown in FIG. 7 and includes a robot 2′ according to a second embodiment of the invention. In this installation the robot 2a according to the first embodiment is complemented by a second, identical or symmetric station 2b placed facing the first station 2a. This second station 2b similarly includes a second clamp 21 including a second mold 211 for closing the second mold 211 around the parison 3. The second mold 211 includes shells 2111. The shells 2111 are movable in a second clamping direction F4 perpendicular to the extrusion direction F1, i.e. horizontally.

The robot 2′ further includes second transfer means, not shown, for transferring the second clamp 21 in a second transfer direction F5 parallel to the first transfer direction F3 between the extrusion head 1 and a second blow-molding station along the first level A.

The robot 2′ includes, at the blow-molding station, a second blow pipe 23 slidably mounted in the extrusion direction F1. The second blow pipe 23 is capable of being inserted, in a blow-molding position, on an end of the parison 3 at the blow-molding station to blow it in the second mold 211 and form a fourth blown object. The second blow pipe 23 is further capable of holding the blown object to bring it to a second level B above the first level A so as to remove the fourth blown object from the second mold 211.

The second clamp 21 further includes second gripping means 212 for picking up again a third blown object 4c retained by the second blow pipe 23 at the second level B.

The robot 2′ further includes second insertion means 24 for inserting a sheet to the surface of each of the cavities 222 when the second mold 211 is at the second blow-molding station, in the open position. The second insertion means 24 are similar to the first insertion means 14.

The robot 2′ also includes a second discharge system 25 positioned to receive the third blown object 4c by the second gripping means 212 upon opening the second clamp 21.

The second station operates like the first station, but with an offset, meaning that the closing of the second mold 211 on the parison 3 is accomplished during the blow-molding of an object in the first mold 111, and conversely. The operation will therefore not be described in more detail.

The invention is not limited to the embodiments which have just been described by way of examples. The first and the second transfer directions F3, F5 are not necessarily parallel, but can be angularly offset when viewed in the horizontal plane. Moreover, they are not necessarily horizontal and can be oriented to descend or to rise toward the blow-molding station. Other improvements commonly used in extrusion blow-molding technique can also be adopted.

1. An extrusion blow-molding method comprising:
extruding at least one parison in an extrusion direction,
closing a first clamp including a first mold around the parison in a first clamping direction perpendicular to the extrusion direction, wherein at least one cavity of the first mold contains at least one sheet, and the first clamp picks up again at least one first blown object retained by at least one first blow pipe,
transferring the first clamp in a first transfer direction inclined with respect to the extrusion direction, and perpendicular to the first clamping direction along a first level,
inserting the first blow pipe on one end of the parison to blow it in the first mold, and form at least one second blown object, the sheet being integrated into the second blown object, and
opening the first mold in the first clamping direction, and retaining the second object on the first blow pipe, and releasing the first blown object on a first discharge system,
wherein, during the step of extruding the parison, when the first mold is opened, the first blown object (4a) is transferred by the first blow pipe from the first level to a second level offset with respect to the first in the extrusion direction, the sheet is placed in the cavity of the first mold by first insertion means, then the first clamp is transferred in the first transfer direction to place the first mold around the parison, and in that the first clamp picks up again the first blown object at the second level during the step of closing the first clamp to transfer it to the first discharge system.

2. The extrusion blow-molding method according to claim 1, further comprising:
in a second open mold, maneuvered by a second clamp, at least one third blown object is transferred by at least one second blow pipe from the first level to the second level,
at least one second sheet is placed in at least one cavity of the second mold by second insertion means,
the second clamp is transferred in the second transfer direction to place the second mold around the parison when the first clamp is withdrawn, and
the second mold is closed around the parison in a second clamping direction perpendicular to the extrusion direction, and the second clamp picks up again the third blown object retained by the second blow pipe at the second level,
the second clamp is transferred in a second transfer direction inclined with respect to the extrusion direction, and perpendicular to the second clamping direction,
the second blow pipe is inserted on one end of the parison to blow it in the second mold, and form at least one fourth blown object, the sheet being integrated into the fourth blown object, and
the second mold is opened in the second clamping direction while retaining the fourth blown object on the second blow pipe, and the third blown object is released on a second discharge system.

3. The extrusion blow-molding method according to claim 1, wherein the first or the second transfer direction is perpendicular to the extrusion direction.

4. The extrusion blow-molding method according to claim 3, wherein the first and the second transfer direction are parallel.

5. The extrusion blow-molding method according to claim 1, according to which the parison is cut transversely during the closure of the mold.

6. A robot for an extrusion blow-molding machine, comprising:
a first clamp including a first mold for closing the first mold around at least one parison extruded by an extrusion head in an extrusion direction, the first mold including shells with cavities, the shells being movable in a first clamping direction perpendicular to the extrusion direction, the first clamp further including first gripping means for picking up again at least one first blown object retained by at least one first blow pipe,
first insertion means for inserting at least one sheet to the surface of at least one of the cavities,
first transfer means for transferring the first clamp in a first transfer direction inclined with respect to the extrusion direction, and perpendicular to the first clamping direction along a first level,
the first blow pipe being capable of being inserted on one end of the parison to blow it in the first mold, and form at least one second blown object, the sheet being integrated into the second blown object, and capable of retaining the second object on the first blow pipe during the opening of the first mold by the first clamp, and
a first discharge system positioned to receive the first blown object by the first gripping means during the opening of the first clamp,
wherein the first blow pipe is arranged for transferring the first blown object from the first level to a second level offset with respect to the first in the extrusion direction so as to remove the first blown object from the first mold, in that the first insertion means are arranged for inserting the sheet facing the first blow pipe, in that the first gripping means are arranged for picking up again the first blown object at the second level during closure of the first clamp to transfer it to the first discharge system, and in that the robot is controlled so as to implement the method according to claim 1.

7. The robot according to claim 6, further including:
a second clamp including a second mold for closing the second mold around the parison in a second clamping direction perpendicular to the extrusion direction, the second mold including shells with cavities, and second gripping means for picking up again at least one third blown object retained by at least one second blow pipe,
second insertion means for inserting at least one sheet to the surface of at least one of the cavities of the second mold,
second transfer means for transferring the second clamp in a second transfer direction inclined with respect to the extrusion direction, and perpendicular to the second clamping direction along the first level,
the second blow pipe being capable of being inserted on one end of the parison to blow it in the second mold, and form at least one fourth blown object, the sheet being integrated into the fourth blown object, the second blow pipe being capable of retaining the fourth object on the second blow pipe during the opening of the second mold by the second clamp, and arranged to transfer the fourth blown object from the first level to the second level (B), and
a second discharge system positioned to receive the third blown object by the second gripping means during the opening of the second clamp,
the second gripping means being arranged to pick up again the third blown object at the second level during the closure of the second clamp to transfer it to the second discharge system, the robot being controlled so as to implement the method according to claim
